(19) United States
(12) Patent Application Publication
(10) Pub. No.: US 2007/0024131 A1
(43) Pub. Date: Feb. 1, 2007

(54) Ventilator for an alternator-starter

(75) Inventors: Blaise Rouleau, Paris (FR); Claudiu Vasilescu, Paris (FR)

Correspondence Address: Longacre & White, 6550 Rock Spring Drive, Suite 240, Bethesda, MD, 20817, US

(73) Assignee: VALEO EQUIPEMENTS ELECTRIQUES MOTEUR, Creteil_Cedex (FR)

(21) Appl. No.: 10/561,848

(22) PCT Filed: Jul. 5, 2004
(86) PCT No.: PCT/FR04/01747

§ 371 Date: May 12, 2006

(30) Foreign Application Priority Data
Jul. 4, 2003 (FR) 03/08234

(51) Int. Cl. H02K 9/06

(52) U.S. Cl. 310/63; 310/68 B

(57) ABSTRACT

This invention relates to a ventilator for an alternator-starter fixed on a rotor (4) with magnetic poles including: a metal insert (13) which is used to fix the ventilator to the rotor: an end shield plate (17) and ventilation blades (12) which are made of a plastic material and which are molded on the metal insert; a magnetic target (14) ensuring metal follow-up of the rotation of the rotor with the aid of at least one associated rotor.

### FIELD OF THE INVENTION

This invention relates to a fan for a motor vehicle alternator, and in particular for an alternator-starter. This fan, which is adapted to be coupled in rotation to the rotor of the alternator-starter, has the particular feature that it incorporates, firstly, a metallic insert and secondly, a magnetic target which enables the rotation of the rotor to be followed.

The invention is applicable in the field of the motor industry, and in particular in the field of alternators and alternator-starters for motor vehicles.

### CURRENT STATE OF THE ART

In a motor vehicle, the alternator converts rotational movement of the inductor rotor, driven by the engine of the vehicle, into electrical current which is induced in the windings of the stator. The alternator may also be reversible. It then constitutes an electric motor which can drive the engine of the vehicle in rotation via the rotor shaft. This reversible alternator is called an alternator-starter, or an alterno-starter, and it converts mechanical energy into electrical energy and vice versa. Thus, an alterno-starter is able to start the engine of the motor vehicle, to constitute an auxiliary motor for the purpose of, for example, driving a compressor for air conditioning purposes, or again it may work in a motor mode for driving the motor vehicle.

In general terms, an alternator-starter converts the rotating movement of the rotor, which is also the inductor and is driven by the engine of the vehicle, into electric current induced in the stator windings. The stator windings and the rotor are connected to an electronic circuit which includes, in particular, a rectifier bridge. In the course of vehicle development, these electronic circuits have become complex, and the more complex the electronic circuit, the more heat it produces. It is therefore imperative to cool it effectively. This is generally achieved by means of a fan which is located close to the electronic circuit, and commonly at the rear end of the rotor. This fan is generally fixed on the rotor of the alternator-starter, in such a way that it is coupled in rotation with the rotor. The fan also cools the stator and the bearing. The fan is conventionally made of a metallic material. The insert is fixed on the rotor by welding, screw fastening or any other fastening technique known in the field. The blades of a metallic fan can only be of simple forms which can be made by stamping and bending from a metal plate. In addition, the number of fan blades is limited as a function of the size of the metal plate. Now in order to be able to cool the electronic circuitry effectively, it is often necessary to have recourse to a large number of fan blades, or blades of complex forms.

At the present time there are in existence fans which are made in a plastics material moulded in situ on a metallic insert. Plastics material has the advantage that it is easier to work than metal. In this connection, the plastics material enables the fan to be made by moulding. It is therefore possible to give more complex and more varied forms to its blades than for a metal fan, or to increase the number of blades. The plastics fan is generally moulded on a metallic insert, which is fixed on the rotor by welding or any other known fastening technique. One example of a plastics fan moulded on a metallic insert is described in the patent application FR-A-2 673 338 of the present Applicant. The fan described in that application is moulded on a metal insert by an in situ moulding operation, disposed in the portion which constitutes a radial web of the fan and which serves for fastening the fan, in particular by welding, to the rotor. The number, configuration and disposition of the blades of the fan are able to be chosen as a function of the application of the fan and the cooling output which it is required to supply.

In addition, in a machine of a reversible type such as an alternator-starter, the rotor is surrounded by a multiphase stator, which is generally three phase. Its multiphase nature necessitates that the angular position and speed of the rotor shall be followed with the aid of following means, for the purpose of control in the electric motor mode, whereby to inject electric current into the appropriate phase winding of the stator at the correct moment. This is described for example in the patent applications FR-2 745 444 and EP-A-0 260 176. Such following means are generally of a magnetic type.

One example of a magnetic following means is described in patent application WO01/69762. In that patent application, the rotary electrical machine of the alternator-starter type includes a hollow support having a front bearing plate and a rear bearing plate, which are connected together and each of which has a central bearing means through which the end of a shaft passes, the shaft carrying a rotor with magnetic poles surrounded by a multiphase stator which is carried internally by the support. The latter includes magnetic means for following the rotation of the rotor, together with at least one sensor associated with a target. In that machine, the target is a target which can be read axially or radially. It is fixed on a target carrier which is mounted on the rotor for rotation and which is fitted axially between the rotor and either the front bearing plate or the rear bearing plate, to which it is adjacent. The front or rear bearing plate adjacent to the target carrier carries the sensor for detecting the passage of the magnetic target. The Hall effect or magneto-resistive sensor, fixed facing the target on the appropriate bearing plate, ensures, in connection with the target, that the rotation of the rotor is followed. The target is positioned on a target carrier which may be of either a magnetic or a non-magnetic type.

Thus in this machine, a metallic fan is incorporated in the rear of the rotor. In addition, a target carrier carrying a magnetic target which, in association with one or more sensors, enables the rotation of the rotor to be followed magnetically, is also incorporated in the rear of the rotor. The target carrier can be a component of sheet metal, or of plastics material, or again, a component of plastics material moulded on a metal component fabricated from sheet metal.

However, the blades of the fan may be complex and occupy some amount of space. In addition, the target carrier has to be mounted close to the fan, while being sufficiently far away from the fan that it does not impede movements of the stream of air driven by the fan blades. This assembly of the fan and target carrier therefore requires a certain amount of space inside the alternator-starter.

In addition, the fitting of the said assembly makes it necessary to carry out a number of steps, namely the fitting of the fan on the rotor with prior verification that the imbalance has been corrected and that the target carrier, with the target, have then been fitted.

### STATEMENT OF THE INVENTION

More precisely, the object of the invention is to incorporate, in the same space, at least one fan and a magnetic follower target. For this purpose, the invention proposes a fan for an alternator-starter of plastics material which is disposed on a metallic insert and which incorporates a magnetic target, which is for example of magnetic plastic. In the invention, the fan acts as a target carrier, which enables the use and fitting of an independent target carrier to be avoided.

More precisely, the invention provides a fan for an alternator-starter, fixed on a rotor, with magnetic poles, of the alternator-starter, the fan comprising:

a metallic insert whereby the fan is fixed on the rotor, the said metallic insert being able to constitute some or all of the blades, so as to give mechanical strength, and

a radial web and at least one fan blade, which are moulded in plastics material on the metallic insert,

characterised in that it includes a magnetic target which, in association with at least one sensor, ensures magnetic following of the rotation of the rotor.

### BRIEF DESCRIPTION OF THE DRAWINGS

FIG. 1 is an axial cross section of an alternator-starter for a motor vehicle, having a fan according to the invention.

FIGS. 2A and 2B show respectively a top plan view and a side view of a fan for an alternator-starter according to the invention.

FIGS. 3A and 3B show, respectively, a top plan view and a side view of another version of the fan for an alternator-starter according to the invention.

FIG. 4 shows a further version of the invention in axial cross section.

### DETAILED DESCRIPTION OF EMBODIMENTS OF THE INVENTION

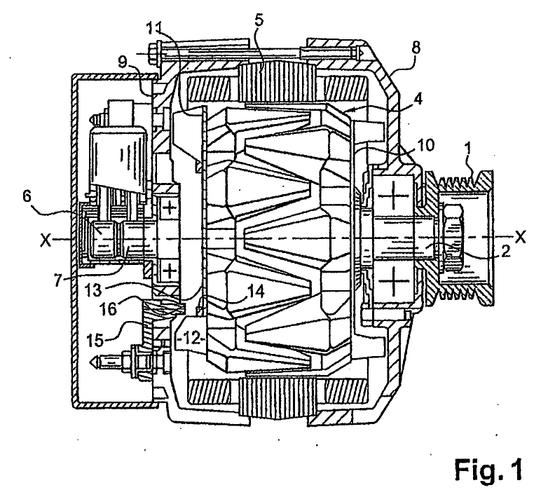

FIG. 1 shows one example of an alternator-starter having a fan according to the invention. This alternator-starter comprises a motion transmission member 1 which is part of a motion transmission device, not shown in the drawing, which is operatively interposed between the engine of the vehicle and the alternator-starter. This motion transmitting member may for example be a toothed wheel, a pulley, or the like. The member 1 is a driven member when the machine is working in its alternator mode, and a driving member when the machine is working in its starter mode.

A rotatable shaft 2, the axial axis of symmetry X-X of which is the axis of rotation of the machine, extends partly through the member 1. The shaft 2 carries a rotor 4, which is for example a rotor of the claw type and which is provided with excitation windings, the ends of which are connected through wire connectors to slip rings 6 and 7 carried by the rear end of the shaft 2.

The rotor 4 is surrounded by a wound stator 5 which includes one or more windings, for example three windings to define three phases.

The rotor 4 is at least partly surrounded by a front bearing plate 8 and a rear bearing plate 9, both of which are fixed on the shaft 2, for example by force fitting.

In the example shown in FIG. 1, the alternator-starter includes a front fan 10 and a rear fan 11. Some alternator-starters have only one fan, which is generally the rear fan 11, the latter being more powerful than the front fan 10. In accordance with the invention, the rear fan 11 includes a metallic insert 13, on which a radial web and fan blades 12 are formed in plastics material by in situ moulding. The fan also includes a magnetic target 14 which is designed to follow the rotation of the rotor. The said magnetic target is associated with at least one sensor 16 which is carried by a sensor carrier 15. In a three phase machine there are preferably three of these sensors, all of which are carried by the sensor carrier 15. The sensor carrier 15 is fixed on the base of the rear bearing plate 9, and more precisely on the face of the rear bearing plate which lies facing the target 14.

The sensors are magnetic in character. They may for example be Hall effect sensors, or they may be sensors of the magneto-resistive type, the resistance of which varies as a function of the magnetic flux.

The sensors 16 and sensor carrier 15 shown in FIG. 1 are of conventional types known to a person working in this field.

In the example shown in FIG. 1, the sensors 16 are fitted in axial facing relationship with the target 14, with an air gap being defined between the sensors and the target in such a way that reading takes place axially. In another embodiment of an alternator-starter, reading could be radial.

The group consisting of the target and sensors enables magnetic following of the rotation of the rotor to be obtained. It is therefore possible to know the angular position of the rotor, and also its speed of rotation, at any instant.

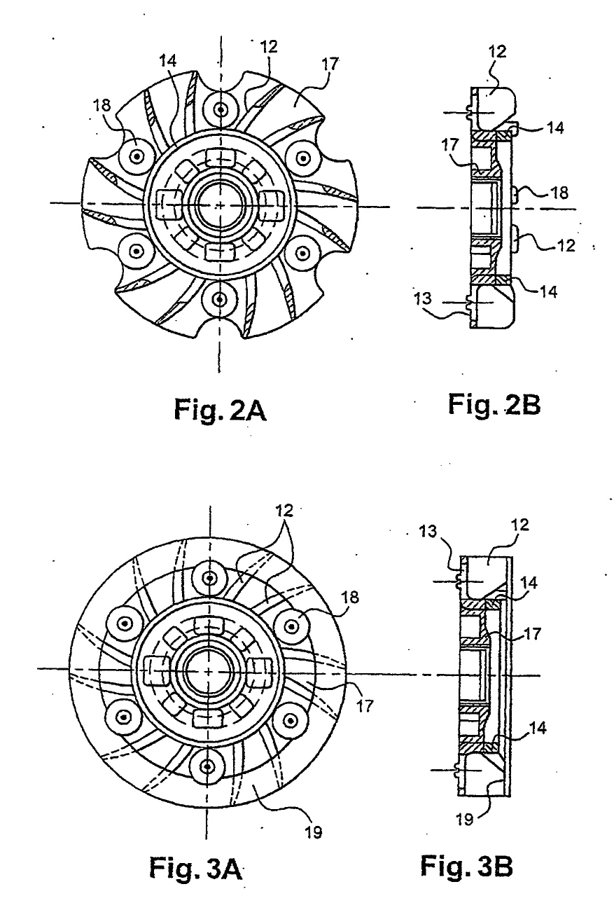

FIGS. 2A and 2B show one embodiment of a fan according to the invention. FIG. 2A shows a top plan view and FIG. 2B a side view of this fan. The fan of the invention comprises a metallic insert 13, on which a plastics material is moulded to form a web 17 and fan blades 12. The fan blades extend from the web 17.

In other words, the fan of the invention comprises an insert 13, which is for example of sheet metal and which is adapted to be fixed on the rotor 4 by known fastening methods such as screw fastening, welding etc. In the embodiment shown in FIGS. 2A and 2B, fastening of the insert 13 on the rotor 4 is achieved by welding. For this purpose, the insert includes depressions 18 which are adapted to receive the weld material during welding of the fan on the rotor. A web 17 and fan blades 12 are moulded in situ on the face of the metallic insert 13 which is opposite to the rotor 4. During the operation of moulding the plastics material on the insert, very great care is taken not to cover the depressions 18 which will later receive the weld material.

In another embodiment, the insert is fastened in place by other fastening means than welding. It may then be that the insert has no depressions 18, or that the depressions are of different dimensions or are differently disposed. The web of the fan is moulded in situ on the insert, and accordingly includes the same depressions as the insert, or else it includes none.

The fan of the invention has the feature of incorporating a target for following the rotation of the rotor. In the embodiment shown in FIGS. 2A and 2B, this target is in the form of a crown element 14 which is moulded in situ on the web 17 of the fan. The said target 14 is made of a mouldable magnetic material, such as a magnetic plastic. A magnetic plastic is a plastics material which contains particles of a magnetic material such as ferrites or rare earths. It is therefore a magnetic material that is capable of being moulded so as to give it the desired form. Thus, in the embodiment in FIGS. 2A and 2B, the magnetic plastic is moulded in the form of a crown element on the web of the fan. It can also be moulded directly on the insert so that it constitutes the web and/or the fan blades.

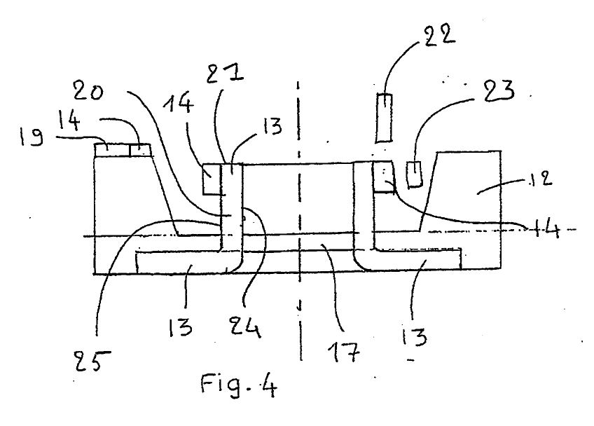

As can be seen in FIG. 4, the target 14 of magnetic plastic material is mounted, in this modified embodiment, in the vicinity of one end 21 of a tubular portion 20 formed on the metallic insert 13. The target is preferably mounted on the outer circumference 25 of this tubular portion. This enables a target to be made with a larger circumference, thereby enabling improved precision as to the position of the rotor to be obtained.

Axial or radial position sensors, 22 or 23 respectively, are then fitted in facing relationship with the said target, so as to determine the position of the rotor.

In another modified version, not shown, the target is located on the inner circumference 24 of the tubular portion, or sleeve. This arrangement has the advantage that it offers the magnetic plastic material a high resistance to centrifugal forces. For reasons relating to the size of the sensors, in this configuration it is preferable that sensors which are positioned axially be chosen.

In a first embodiment, the said target, made of magnetic plastic material, is moulded beforehand. It is then placed on the end of the sleeve and is held on the said sleeve, for example by adhesive means which are known per se.

In a second embodiment, the said target in magnetic plastic material is formed directly by in situ moulding in the vicinity of the end of the sleeve. Thus, the magnetic plastic is moulded directly in such a way as to give a magnetic target.

In one or other of the methods of fitting or making the target described above, it will preferably be desired to obtain the smallest possible air gap between the magnetic plastic and the metallic sleeve. This very small air gap has the advantage that it produces good looping of the magnetic flux from the target, which enables less sensitive sensors to be used.

In this way a fan is obtained which includes a metallic insert on which at least one blade and a magnetic target are moulded. In a modified version, the metallic insert may also include at least one metallic blade, the fan including a first group of blades of plastics material, and a second group of blades which are of metal. A plastics web 17, the purpose of which is to give the plastics blades some mechanical strength, is also moulded in situ on the insert.

In a modified version of the invention, the magnetic target is made by introducing elements of magnetic material such as ferrites or rare earths into the plastics material of which the web and/or the blades of the fan are made.

In the example shown in FIGS. 2A and 2B, the fan blades are spaced apart in pairs between two depressions 18. The number and distribution of the blades can of course be different, according to the cooling requirements.

Similarly, in FIGS. 2A and 2B the blades have a form in which they are slightly curved towards the right. The form of these blades may of course be different. The fan blades of the invention may take any possible forms, the simplest or the most complex, that are able to be made for a fan of plastics material moulded on a metallic insert.

Similarly, in the example shown in FIGS. 2A and 2B, the fan has only one stage of fan blades. However, the fan of the invention may include a double stage of blades, or even a triple stage.

In other words, the fan of the invention may be made with any possible variants that are known for fans of plastics material moulded on a metallic insert.

Moreover, the fact that the insert is of metal, for example sheet steel, enables known fastening techniques, previously used with known fans of plastics material moulded in situ on a metallic insert, to be used. This metallic insert, besides its functions of mechanical strength of the fan and fastening of the fan on the rotor, provides magnetic guidance of the magnetic material that constitutes the target.

FIGS. 3A and 3B show a further embodiment of the fan of the invention. As in the embodiment described above, the fan is made of a plastics material which is moulded on a metallic insert 13. In this embodiment, the fan includes, as in FIGS. 2A and 2B, a web 17, fan blades 12 and depressions 18.

In this embodiment of the invention, the ventilator includes a crown element 19 of plastics material in the form of a shroud ring. In this connection, in some machines the heat dissipater is mounted in a mezzanine position on the rear bearing plate of the alternator-starter, as is described for example in the document WO2004/040738. It can also be mounted directly on the rear bearing plate. In this case, it is important that the air stream which enters from the side into the heat dissipater should come radially towards the centre of the dissipater.

In the invention it is proposed to mould the shroud ring at the same time as the web and the fan blades. This shroud ring consists of the crown element 19, situated at the end of the blades opposite to the web. The said crown element 19 constitutes a kind of partial cover for the summit, or blade tips, of the fan. In this embodiment the fan blades extend from the web 17 to the crown element 19.

In a modified version, the fan blades are spaced apart in two stages, the blades of one of the stages having a greater spread. In other words, the blades of the two stages are of different heights. In that case the crown element is situated at the summit of the higher blades.

Thus in the embodiment of FIGS. 3A and 3B, the function of the shroud ring is performed intrinsically by the fan itself, because of the presence of the crown element 19. The crown element 19 also has the advantage that it prevents volumetric losses above the blades of the fan, which improves the operation of the fan even more, that is to say the mass flow of air supplied by the fan when the latter is in rotation. As a result, as the flow of air produced by the fan is increased, it is then possible to reduce the height of the blades of the fan, which enables the size of the latter to be reduced.

In addition, the crown element 19 is formed by simultaneous moulding with the fan. The mounting of the shroud ring therefore does not constitute an additional assembly operation. The shroud ring is accordingly fitted simultaneously with the remainder of the fan.

The magnetic plastic material can also be moulded in other forms on the web of the fan. It may also overlie a part, or all, of the web and/or of the fan blades. The target 14 can be, and preferably is, moulded in situ or adhesively bonded against the cover, as can be seen for example in the left hand blade in FIG. 4.

In a modified version of the invention, the fan may include a powder pot. It will be recalled that the connecting wires of the rotor are connected to the collector, and that in order to avoid any risk of movement of these wires during rotation of the fan, they are fixed by means of a powder in a powder pot. This powder is generally epoxy resin. In the invention, the powder pot can be located on the web of the fan or on the crown element of the fan, in a location which is delimited by two blades.

In the invention, the fan may be centred on the rotatable shaft of the alternator-starter. This enables centring of the ventilator to be facilitated, and limits balancing problems. In this connection, the fact that the ventilator is made of plastics material offers the possibility of balancing the fan before it is fitted in place. In this way balancing problems can be reduced.

In the invention, centring of the fan, the target carrier and the shroud ring on the rotating shaft are carried out in a single operation.

Made in the above way, the fan according to the invention has a raised performance, since it takes various and complex forms, while combining the functions of a magnetic target and, in a modified version, of a shroud ring and/or a powder pot.

The fan has the advantage that its fitting is simplified because it combines at least three components in a single one, namely the insert, the fan and the magnetic target. The shroud ring 19 can also be added to this. The fitting of the fan, incorporating the magnetic target, on the fan is performed in a single operation identical to a conventional operation of fitting a fan of plastics moulded in situ on a metallic insert. The manufacturing cost of the fan of the invention is also reduced, because it is possible to make the fan and the shroud ring in a single moulding operation. Moreover, manufacture of a target carrier is not useful because the fan itself acts as the target carrier.

In addition, the use of plastics material for making the fan, target and shroud ring enables cooling to be improved and therefore enables the chignons of the stator to be more effectively cooled, which reduces electromagnetic losses, and this leads to better performance of the machine.

1. A fan for an alternator-starter, fixed on a rotor (4), with magnetic poles, of the alternator-starter, the fan comprising:
a metallic insert (13) whereby the fan is fixed on the rotor, and
a radial web (17) and at least one fan blade (12), which are moulded in plastics material on the metallic insert,
characterised in that it includes a magnetic target (14) which, in association with at least one sensor, ensures magnetic following of the rotation of the rotor.

2. A fan according to claim 1, characterised in that the magnetic target (14) is moulded in situ on the metallic insert (13).

3. A fan according to claim 1, characterised in that the magnetic target (14) is adhesively bonded on the metallic insert (13).

4. A fan according to claim 1, characterised in that the magnetic target (14) is mounted on a tubular portion (20) of the metallic insert (13).

5. A fan according to claim 4, characterised in that the magnetic target (14) is mounted on an internal wall (24) of the tubular portion (20).

6. A fan according to claim 4, characterised in that the magnetic target (14) is mounted on the external wall (25) of the tubular portion (20).

7. A fan according to claim 1, characterised in that the magnetic target comprises a magnetic material combined with the plastics material of the web and/or fan blades.

8. A fan according to claim 1, characterised in that the magnetic material of the target comprises ferrites or rare earths.

9. A fan according to claim 1, characterised in that the magnetic material of the target is a magnetic plastic material.

10. A fan according to claim 1, characterised in that it includes a crown element (19) of plastics material constituting a shroud ring, with at least some of the blades of the fan extending from the web to the crown element.

11. A fan according to claim 10, characterised in that the magnetic target (14) is mounted on the cover (19).

12. A fan according to claim 10, characterised in that the magnetic target (14) is mounted against the inner circumference of the cover (19).

13. A fan according to claim 1, characterised in that it constitutes a powder pot for the connecting wires of the rotor.

14. A fan according to claim 1, characterised in that the blades are of complex form.

15. A fan according to claim 1, characterised in that the fan blades are spaced apart over at least two stages.

16. A fan according to claim 1, characterised in that the fan blades are spaced apart over at least two stages.

17. A fan according to claim 1, characterised in that one group of blades is of plastics material moulded in situ on the metallic insert, and in that the remainder of the blades are of metal projecting integrally from the metallic insert.

18. A fan according to claim 2, characterised in that the magnetic target (14) is mounted on a tubular portion (20) of the metallic insert (13).

19. A fan according to claim 3, characterised in that the magnetic target (14) is mounted on a tubular portion (20) of the metallic insert (13).
